(19) United States
(12) Patent Application Publication
(10) Pub. No.: US 2024/0421616 A1
(43) Pub. Date: Dec. 19, 2024

(54) BATTERY PROTECTING DEVICE AND METHOD

(71) Applicant: LG ENERGY SOLUTION, LTD., Seoul (KR)

(72) Inventors: Hak In KIM, Daejeon (KR); Jisoo PARK, Daejeon (KR)

(73) Assignee: LG ENERGY SOLUTION, LTD., Seoul (KR)

(21) Appl. No.: 18/703,120

(22) PCT Filed: Aug. 11, 2023
(86) PCT No.: PCT/KR2023/011910

§ 371 Date: Apr. 19, 2024

(30) Foreign Application Priority Data
Sep. 8, 2022 (KR) 10-2022-0114087

(51) Int. Cl. H02J 7/00; H01M 10/42; H01M 10/44

(52) U.S. Cl. CPC H02J 7/0031; H01M 10/425; H01M 10/443; H02J 7/00712; H01M 2010/4278

(57) ABSTRACT

Discussed is a protection apparatus that may identify an accumulated charging time period of a charging current applied at least one battery cell and determine whether to permanently block charging and discharging of the at least one battery cell by comparing an accumulated charging time period with a predetermined threshold time period, thereby preventing battery cell ignition due to lithium plating occurring in the battery cell caused from a charging current.

### TECHNICAL FIELD

This application claims priority to and the benefit of Korean Patent Application No. 10-2022-0114087 filed in the Korean Intellectual Property Office on Sep. 8, 2022, the entire contents of which are incorporated herein by reference.

The present invention relates to a battery protection apparatus and method, and more particularly, to a battery protection apparatus and method for preventing lithium plating in a battery cell due to charging current during charging and discharging a battery.

### BACKGROUND ART

As the price of energy sources rises due to the depletion of fossil fuels and interest in environmental pollution increases, a demand for secondary batteries as an eco-friendly alternative energy source is rapidly increasing.

Among secondary batteries, lithium batteries may be applied to various industrial such as mobile applications, fields automobiles, robots, and energy storage devices as a response to today's environmental regulations and high oil price issues.

These lithium batteries are generally classified into cylindrical, prismatic, or pouch types depending on a shape of the exterior material in which the electrode assembly is accommodated.

Among these, cylindrical batteries may be provided in a battery pack (Cell To Pack; CTP) structure including a plurality of battery cells.

Due to its nature of the battery cell, cylindrical batteries are subject to lithium plating caused from low-temperature charging or charging current due to regenerative braking which is generated by motors of cars and bicycles, and the lithium plating may cause ignition.

Accordingly, a battery protection device according to the prior art was provided by setting a condition to block charging of battery cells at temperature below 0° C., considering that the minimum charging temperature of a typical cylindrical battery cell is 0° C.

However, if a delay occurs before the condition is applied in the conventional battery protection device, battery cell charging may proceed for a while and lithium may precipitate (Li-plate) when such cases accumulate, which results in a risk that the battery cell may ignite.

Accordingly, when charging a battery cell according to the prior art, if the temperature of the battery cell falls below 0° C., a method of blocking charging current from being generated by the battery system and charger control may be used, but this method has a limit of difficulty when facing a battery system fault.

### DETAILED DESCRIPTION OF THE INVENTION

### Technical Problem

To obviate one or more problems of the related art, embodiments of the present disclosure provide a battery protection apparatus.

To obviate one or more problems of the related art, embodiments of the present disclosure also provide a battery protection method.

### Technical Solution

In order to achieve the objective of the present disclosure, an apparatus for protecting at least one battery cell located inside a battery system may include at least one processor and a memory configured to store at least one instruction which, when executed by the at least one processor, causes the at least one processor to perform an operation to check an accumulated charging time period of a charging current applied to the at least one battery cell under a temperature condition less than or equal to a predetermined threshold temperature; and an operation to determine whether to permanently block charging and discharging of the at least one battery cell by comparing the accumulated charging time period with a predetermined threshold time period.

The operation to determine whether to permanently block charging and discharging of the at least one battery cell may include an operation to permanently block charging and discharging of the at least one battery cell in an instance that the accumulated charging time period is greater than or equal to the predetermined threshold time period.

The operation to determine whether to permanently block charging and discharging of the at least one battery cell may include: an operation to identify an operation mode of the at least one battery cell in an instance that the accumulated charging time period is less than the predetermined threshold time period; and an operation to compare a charging time period of the at least one battery cell under the temperature condition less than or equal to the predetermined threshold temperature according to the operation mode with at least one predefined time period and to control charging and discharging of the at least one battery according to a comparison result.

The operation to control charging and discharging of the at least one battery cell may include an operation to: upon the at least one battery cell being charged for more than or equal to a first time period under the temperature condition of less than or equal to the predetermined threshold temperature in a charge mode, control the battery system to prevent charging of the at least one battery cell by transmitting a first control signal to the battery system.

The operation to control charging and discharging of the at least one battery cell may include an operation to: upon the at least one battery cell being charged for more than or equal to a second time period under the temperature condition of less than or equal to the predetermined threshold temperature in a charge mode, transmit a second control signal to the at least one battery cell to block a charging switch of the at least one battery cell to prevent charging of the at least one battery cell.

The operation to control charging and discharging of the at least one battery cell may include an operation to: upon the at least one battery cell being charged for more than or equal to a third time period under a temperature condition of less than or equal to a predefined first discharge temperature in a discharge mode, transmit a third control signal to the battery system to control an amount of output current of the at least one battery cell.

The operation to control the amount of output current may include an operation to control reducing the amount of output current required for the at least one battery cell to a threshold value or less in the discharge mode.

The operation to control charging and discharging of the battery cell may include an operation to: upon the at least one battery cell being charged for more than or equal to a fourth time period under a temperature condition of less than or equal to a predefined second discharge temperature in a discharge mode, transmit a fourth control signal to the battery system to block a switch within the battery system to prevent discharging of the at least one battery cell.

The operation to control charging and discharging of the battery cell may include an operation to: upon the at least one battery cell being charged for more than or equal to a fifth time period under a temperature condition of less than or equal to a predefined third discharge temperature in a discharge mode, transmit a fifth control signal to the at least one battery cell to block a discharge switch of the at least one battery cell.

The charging of the at least one battery cell according to the operation mode may be generated by a charger in a charge mode and by a regenerative braking current in a discharge mode.

The operation to determine whether to permanently block charging and discharging of the at least one battery cell may include an operation to update the accumulated charging time period by reflecting the charging time in the accumulated charging time period.

The predetermined threshold time period may be a predetermined period as a charging time period during which lithium plating does not occur in the at least one battery cell at a certain temperature.

According to another embodiment of the present disclosure, a method for protecting at least one battery cell located inside a battery system may include identifying an accumulated charging time period of a charging current applied to the at least one battery cell under a temperature condition less than or equal to a predetermined threshold temperature; and determining whether to permanently block charging and discharging of the at least one battery cell by comparing the accumulated charging time period with a predetermined threshold time period.

The determining whether to permanently block charging and discharging of the at least one battery cell may include permanently blocking charging and discharging of the at least one battery cell in an instance that the accumulated charging time period is greater than or equal to the predetermined threshold time period.

The determining whether to permanently block charging and discharging of the at least one battery cell may include identifying an operation mode of the at least one battery cell in an instance that the accumulated charging time period is less than the predetermined threshold time period; and comparing a charging time period of the at least one battery cell under the temperature condition less than or equal to the predetermined threshold temperature according to the operation mode with at least one predefined time period and controlling charging and discharging of the predetermined battery according to a comparison result.

The controlling charging and discharging of the at least one battery according to the comparison result may include, upon the at least one battery cell being charged for more than or equal to a first time period under the temperature condition of less than or equal to the predetermined threshold temperature in a charge mode, controlling the battery system to prevent charging of the at least one battery cell by transmitting a first control signal to the battery system.

The controlling charging and discharging of the at least one battery according to the comparison result may include, upon the at least one battery cell being charged for more than or equal to a second time period under the temperature condition of less than or equal to the predetermined threshold temperature in a charge mode, transmitting a second control signal to the at least one battery cell to block a charging switch of the at least one battery cell to prevent charging of the at least one battery cell.

The controlling charging and discharging of the at least one battery according to the comparison result may include, upon the at least one battery cell being charged for more than or equal to a third time period under a temperature condition of less than or equal to a predefined first discharge temperature in a discharge mode, transmitting a third control signal to the battery system and controlling an amount of output current of the at least one battery cell.

The controlling the amount of output current of the at least one battery cell may include controlling to reduce the amount of output current required for the at least one battery cell to a threshold value or less in the discharge mode.

The controlling charging and discharging of the at least one battery according to the comparison result may include, upon the at least one battery cell being charged for more than or equal to a fourth time period under a temperature condition of less than or equal to a predefined second discharge temperature in a discharge mode, transmitting a fourth control signal to the battery system to block a switch within the battery system to prevent discharging of the at least one battery cell.

The controlling charging and discharging of the at least one battery according to the comparison result may include, upon the at least one battery cell being charged for more than or equal to a fifth time period under a temperature condition of less than or equal to a predefined third discharge temperature in a discharge mode, transmitting a fifth control signal to the at least one battery cell to block a discharge switch of the at least one battery cell.

The charging of the at least one battery cell according to the operation mode may be generated by a charger in a charge mode and by a regenerative braking current in a discharge mode. The determining whether to permanently block charging and discharging of the at least one battery cell may include updating the accumulated charging time period by reflecting the charging time in the accumulated charging time period. The predetermined threshold time period may be a predetermined period as a charging time period during which lithium plating does not occur in the at least one battery cell at a certain temperature.

### Advantageous Effects

The battery protection apparatus and method according to the embodiment of the present invention as described above can prevent battery cell ignition due to lithium plating occurring in a battery cell caused from charging current.

### BRIEF DESCRIPTION OF THE DRAWINGS

FIG. 1 is a block diagram of a battery system to which embodiments of the present invention may be applied.

FIG. 2 is a block diagram of a battery protection apparatus according to embodiments of the present invention.

FIG. 3 is a flowchart for explaining a battery protection method operated by a processor in a battery protection apparatus according to embodiments of the present invention.

FIG. 4 is a flowchart illustrating a method of determining whether to permanently block charging and discharging of a battery cell among the battery protection methods according to embodiments of the present invention.

FIG. 5 is a flowchart illustrating a method of controlling charging and discharging operations of a battery cell in a battery protection method according to embodiments of the present invention.

FIG. 6 is a flowchart for explaining operations according to control signals in charge mode among the battery protection method according to embodiments of the present invention.

FIG. 7 is a flowchart for explaining operations according to control signals in a discharge mode among the battery protection methods according to embodiments of the present invention.

1000: battery protection apparatus
100: memory
200: processor
300: transceiver
400: input interface
500: output interface
600: storage device
700: bus

### BEST MODES FOR PRACTICING THE DISCLOSURE

The present invention may be modified in various forms and have various embodiments, and specific embodiments thereof are shown by way of example in the drawings and will be described in detail below. It should be understood, however, that there is no intent to limit the present invention to the specific embodiments, but on the contrary, the present invention is to cover all modifications, equivalents, and alternatives falling within the spirit and technical scope of the present invention. Like reference numerals refer to like elements throughout the description of the figures.

It will be understood that, although the terms such as first, second, A, B, and the like may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, “and/or” the term includes combinations of a plurality of associated listed items or any of the plurality of associated listed items.

It will be understood that when an element is referred to as being “coupled” or “connected” to another element, it can be directly coupled or connected to the other element or an intervening element may be present. In contrast, when an element is referred to as being “directly coupled” or “directly connected” to another element, there is no intervening element present.

The terms used herein is for the purpose of describing specific embodiments only and are not intended to limit the present invention. As used herein, the singular forms “a”, “an” and “the” are intended to include the plural forms as well, unless the context clearly indicates otherwise. It will be further understood that the terms “comprises”, “comprising”, “includes”, “including” and/or “having”, when used herein, specify the presence of stated features, integers, steps, operations, constitutional elements, components and/or combinations thereof, but do not preclude the presence or addition of one or more other features, integers, steps, operations, constitutional elements, components, and/or combinations thereof.

Unless otherwise defined, all terms used herein, including technical and scientific terms, have the same meanings as commonly understood by one skilled in the art to which the present invention belongs. It will be further understood that terms, such as those defined in commonly used dictionaries, should be interpreted as having meanings that are consistent with their meanings in the context of the relevant art and will not be interpreted in an idealized or overly formal sense unless expressly so defined herein.

Hereinafter, exemplary embodiments of the present invention will be described in detail with reference to the accompanying drawings.

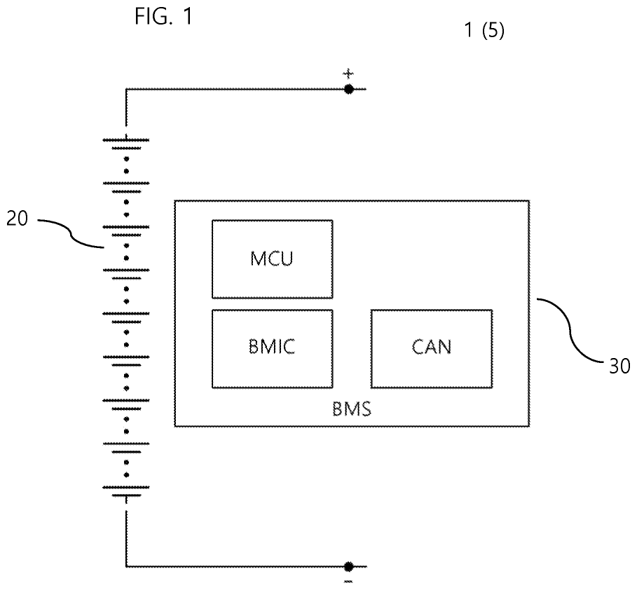

FIG. 1 is a block diagram of a battery system to which embodiments of the present invention may be applied.

Referring to FIG. 1, a battery pack 1 or battery module 5 may include a plurality of battery cells 20 connected in series. The battery pack 1 or module 5 may be connected to a load through a positive terminal (+) and a negative terminal (−) to perform charging or discharging. The most commonly used battery cell is a lithium-ion (Li-Ion) battery cell.

A battery management system (BMS) 30 may be connected to a battery module or battery pack.

The battery management system may monitor a current, a voltage and a temperature of each battery cell or module to be managed, calculate a state of charge (SOC) of the battery based on monitoring results to control charging and discharging. Here, the State of Charge (SOC) refers to a current state of charge of a battery, represented in percent points [%], and the State of Health (SOH) may be a current condition of a battery compared to its ideal conditions, represented in percent points [%].

The BMS may monitor battery cells, read cell voltages, and transmit them to other systems connected to the battery.

Furthermore, the battery management system monitors at least one electrical component constituting the battery system and passes their status data on to other systems. For this, the BMS includes a communication module for communicating with other systems in a device including the battery system.

The communication module of the BMS can communicate with other systems in the device using CAN (Controller Area Network). Here, components, modules or systems in the BMS are connected to each other through a CAN bus. Accordingly, the battery management system (BMS) may use CAN communication to remotely transmit status data obtained through monitoring of the battery pack or module and at least one electrical component constituting the battery management system (BMS) to other systems.

Furthermore, the battery management system (BMS) may equally balance charges of the battery cells in order to extend the life of the battery system.

The BMS 30 may include various components such as a fuse, a current sensing element, a thermistor, a switch, and a balancer to perform such operations. In most cases, a micro controller unit (MCU) or a battery monitoring integrated chip (BMIC) for interworking with and controlling these components is additionally included in the BMS. Here, the BMIC may be located inside the battery management system (BMS) and may be an IC-type component that measures information such as voltage, temperature, and current of the battery cell/module. According to an embodiment, a battery management system (BMS) may be applied to an automobile.

Meanwhile, generally, a battery management system (BMS) is connected with a battery protection apparatus, and the battery protection apparatus blocks a charging and discharging circuit when a battery abnormality occurs. In other words, a general battery protection circuit limits use of the battery by blocking the charging and discharging circuit when an abnormality occurs in any one battery cell or module.

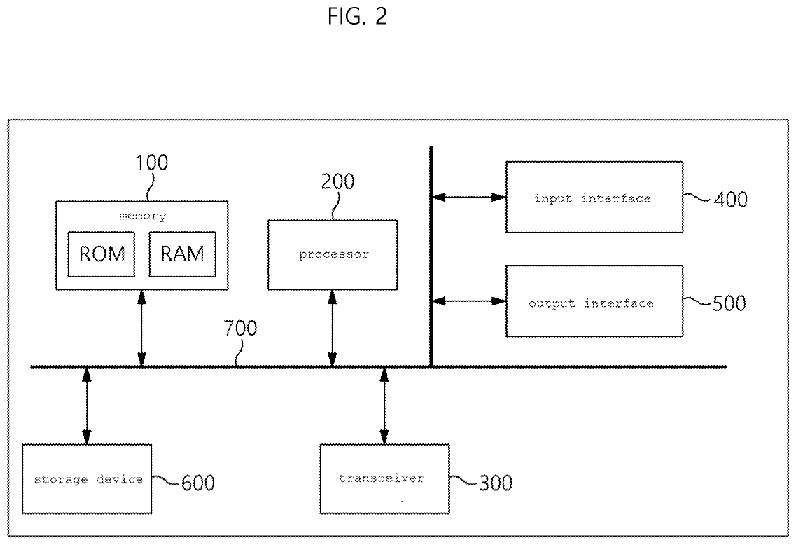

FIG. 2 is a block diagram of a battery protection apparatus according to embodiments of the present invention.

Referring to FIG. 2, the battery protection apparatus according to embodiments of the present invention may control charging and discharging operation of a battery cell by comparing a charging period of time at a certain temperature with a preset condition value if at least one battery cell in the battery system operates below a preset threshold temperature.

In addition, the battery protection apparatus may calculate accumulated charging time period of the battery cells to be charged below or equal to a predetermined threshold temperature and permanently control operation of the battery cells.

In more detail as to each component of the battery protection apparatus according to embodiments of the present invention, the battery protection apparatus may include a memory 100, a processor 200, a transceiver 300, an input interface 400, an output interface 500, and a storage device 600.

According to embodiments, respective components 100, 200, 300, 400, 500, 600 included in the battery protection apparatus may be connected by a bus 700 to communicate with each other.

The memory 100 and the storage device 600 among the components 100, 200, 300, 400, 500, 600 may include at least one of a volatile storage medium and a non-volatile storage medium. For example, the memory 100 and the storage device 600 may include at least one of read only memory (ROM) and random access memory (RAM).

Among them, the memory 100 may include at least one instruction executed by the processor 200.

According to embodiments, the at least one instruction may include an instruction to check accumulated charging time period of charging current applied to the battery cell under a temperature condition less than or equal to a predetermined threshold temperature; and an instruction to determine whether to permanently block charging and discharging of the battery cell by comparing the accumulated charging time period with a predetermined threshold time period.

The instruction to determine whether to permanently block charging and discharging of the battery cell may include an instruction to permanently block charging and discharging of the battery cell in the instance that the accumulated charging time period is greater than or equal to the threshold time period.

The instruction to determine whether to permanently block charging and discharging of the battery cell may include: an instruction to identify the operation mode of the battery cell in the instance that the accumulated charging time period is less than the threshold time period; and an instruction to compare the charging time period of the battery cell under the temperature condition less than or equal to the predetermined threshold temperature according to the operation mode with at least one predefined time period and to control charging and discharging of the battery according to the comparison result.

The instruction to control charging and discharging of the battery cell may include an instruction to: upon the battery cell being charged for more than or equal to a first time period under the temperature condition of less than or equal to the threshold temperature in a charge mode, control the battery system to prevent charging of the battery cell by transmitting a first control signal to the battery system.

The instruction to control charging and discharging of the battery cell may include an instruction to: upon the battery cell being charged for more than or equal to a second time period under the temperature condition of less than or equal to the threshold temperature in the charge mode, transmit a second control signal to the battery cell to block a charging switch of the battery cell to prevent charging of the battery cell.

The instruction to control charging and discharging of the battery cell may include an instruction to: upon the battery cell being charged for more than or equal to a third time period under a temperature condition of less than or equal to a predefined first discharge temperature in a discharge mode, transmit a third control signal to the battery system to control an amount of output current of the battery cell.

The instruction to control the amount of output current may include an instruction to control reducing the amount of output current required for the battery cell to a threshold value or less in the discharge mode.

The instruction to control charging and discharging of the battery cell may include an instruction to: upon the battery cell being charged for more than or equal to a fourth time period under a temperature condition of less than or equal to a predefined second discharge temperature in a discharge mode, transmit a fourth control signal to the battery system to block a switch within the battery system to prevent discharging of the battery cell.

The instruction to control charging and discharging of the battery cell may include an instruction to: upon the battery cell being charged for more than or equal to a fifth time period under a temperature condition of less than or equal to a predefined third discharge temperature in a discharge mode, transmit a fifth control signal to the battery cell to block a discharge switch of the battery cell.

The charging of the battery cell according to the operation mode may be generated by a charger in the charge mode and by regenerative braking current in the discharge mode.

The instruction to determine whether to permanently block charging and discharging of the battery cell may include an instruction to update the accumulated charging time period by reflecting the charging time in the accumulated charging time period.

The predetermined threshold time period may be a predetermined period as a charging time period during which lithium plating does not occur in the battery cell by adjusting a charging time period of the battery cell at a certain temperature.

Meanwhile, the processor 200 may mean a central processing unit (CPU), a graphics processing unit (GPU), or a dedicated processor on which methods according to embodiments of the present invention are performed.

The processor 200 may execute at least one program command stored in the memory 100 as described above.

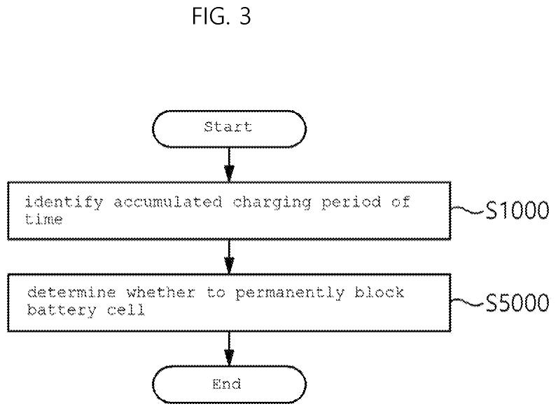

FIG. 3 is a flowchart for explaining a battery protection method operated by a processor in a battery protection apparatus according to embodiments of the present invention.

Referring to FIG. 3, the battery protection apparatus according to embodiments of the present invention may identify an accumulated charging period of time during which charging current is applied to at least one battery cell according to operations of the processor 200 (S1000).

In more detail, the battery protection apparatus may identify an accumulated charging period of time during which charging current is applied to at least one battery cell below a preset threshold temperature. In other words, the battery protection apparatus may check the accumulated charging period of time that accumulates the period during which the battery cell is charged equal to or under a temperature condition below a predetermined threshold temperature. Here, the predetermined threshold temperature may be 0° C. or lower.

Thereafter, the battery protection apparatus may determine whether to permanently block charging and discharging of the battery cell based on the accumulated charging time period (S5000).

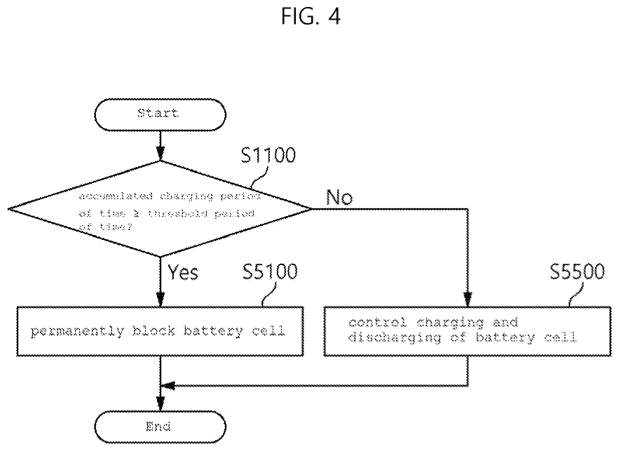

FIG. 4 is a flowchart illustrating a method of determining whether to permanently block charging and discharging of a battery cell among the battery protection methods according to embodiments of the present invention.

Referring to FIG. 4, the battery protection apparatus may then compare the accumulated charging time period with a predefined threshold period of time (S1100).

Here, the predefined threshold period of time is information determined according to experimental data conducted in advance as follows and may be adjusted and predetermined to a charging time period of charging current applied to the battery at a certain temperature so that the determined charging time period ensures no lithium plating occurring in the battery cell.

### Preliminary Experiment to Determine Threshold Period of Time

Battery cells with an initial voltage of 4.1V under a temperature condition of −20° C. or lower were prepared. Afterwards, the charging and discharging cycles of the battery cells were applied differently at 10, 30, 50, 100 and 500 times, in other words, the charging time periods of the charging currents were set differently and charging current was applied at 5A per 0.25 seconds.

Here, a 5 second pause was interposed between charging and discharging operations. Thereafter, monitoring on whether lithium is deposited in the battery cell is performed, and any one of at least one charging time period in which lithium is not deposited may be selected as a threshold period of time.

Accordingly, the selected threshold period of time may be used as comparison data with the accumulated charging period of the battery cell in the battery protection apparatus according to embodiments of the present invention.

Referring again to FIG. 4, according to one embodiment, the battery protection apparatus may permanently block charging and discharging operations of the battery cell when the accumulated charging period of time is equal to or more than the predetermined threshold time period (S5100).

According to another embodiment, the battery protection apparatus may control charging and discharging operations of the battery cell when the accumulated charging period is less than the predetermined threshold time period (S5500).

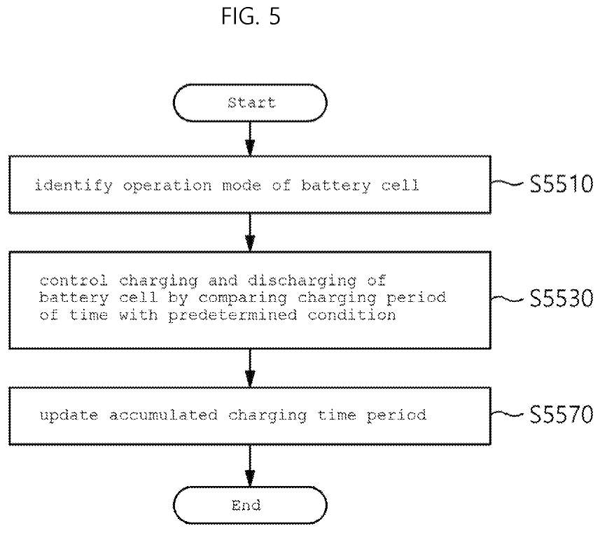

FIG. 5 is a flowchart illustrating a method of controlling charging and discharging operations of a battery cell in a battery protection method according to embodiments of the present invention.

Referring to FIG. 5, the battery protection apparatus may identify an operation mode of the battery cell when the accumulated charging time period is less than the predetermined threshold time period (S5510).

Thereafter, the battery protection apparatus may control charging and discharging operations of the battery cell by comparing the charging time period with preset conditions according to the operation mode of the battery cell (S5530). In other words, when the charging time period satisfies a preset condition according to the operation mode of the battery cell, the battery protection apparatus may transmit a control signal corresponding to the condition to an operating subject, thereby controlling charging and discharging operations of the battery cell. Here, the charging time period may be a charging period of time during which charging current is applied to the battery cell. In other words, it may be a charging time period during which the battery cell is being charged. For example, the preset condition may be a charging period in which the battery is continuously being charged at a preset threshold temperature.

Thereafter, the battery protection apparatus may update the accumulated charging period by reflecting the charging period into the accumulated charging period (S5570).

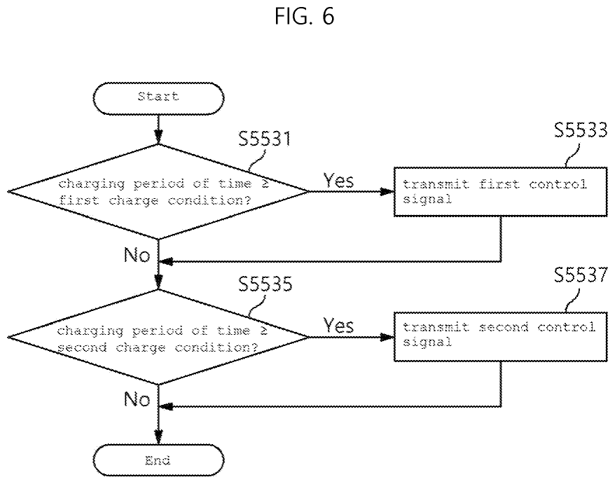

FIG. 6 is a flowchart for explaining operations according to control signals in charge mode among the battery protection method according to embodiments of the present invention.

Referring to FIG. 6, when in a charge mode, the battery protection apparatus may check whether the charging time period satisfies a first charge condition (S5531).

More specifically, when the battery protection apparatus operates in a charge mode, if charging of the battery cell continues for longer than a first time period under a temperature condition equal to or below a predetermined threshold temperature, the battery protection apparatus may output a first control signal and transmit it to the battery system (S5533). For example, the predetermined threshold temperature may be 0° C. and the first time period may be 1 second.

When the battery system receives the first control signal, the battery system may control to prevent inflow of charging current applied to the battery cell. In other words, the battery system may stop charging the battery cell.

Thereafter, the battery protection apparatus may transmit a first release signal to the battery system when the temperature of the battery cell exceeds the predetermined threshold temperature and continues for equal to or longer than a second time period and the accumulated charging time period is less than the predetermined threshold time period. In other words, the battery protection apparatus may cancel the interruption of charging of the battery cells of the battery system.

Accordingly, the battery system may control the charging current to flow into the battery cell to re-charge the battery cells. For example, the predetermined threshold temperature may be 0° C., the second time period may be 3 seconds, and the predetermined threshold period may be less than 25 sec.

Meanwhile, in a charge mode, the battery protection apparatus may check whether the charging time period satisfies a second charging condition (S5535).

More specifically, when the battery protection apparatus operates in a charge mode, if charging of the battery cell continues for more than a second time period under a temperature condition equal to or below the predetermined threshold temperature, the battery protection apparatus may output a second control signal and transmit it to the battery cells (S5537). For example, the predetermined threshold temperature may be 0° C., the second time period may be 3 seconds.

When the battery cell receives the second control signal, the battery system may block a charge switch to prevent the charging current from flowing into the battery cells. Here, the charge switch may be a charge-FET (C-FET).

Thereafter, the battery protection apparatus may transmit a second release signal to the battery system if battery cell charging continues for a second time period during which the temperature of the battery cell exceeds the predetermined threshold temperature and if the accumulated charging time period is less than the predetermined threshold time period. Accordingly, the battery cells may resume charging by connecting the charge switch. For example, the predetermined threshold temperature may be 0° C., the second time period may be 3 seconds, and the preset threshold period may be less than 25 sec.

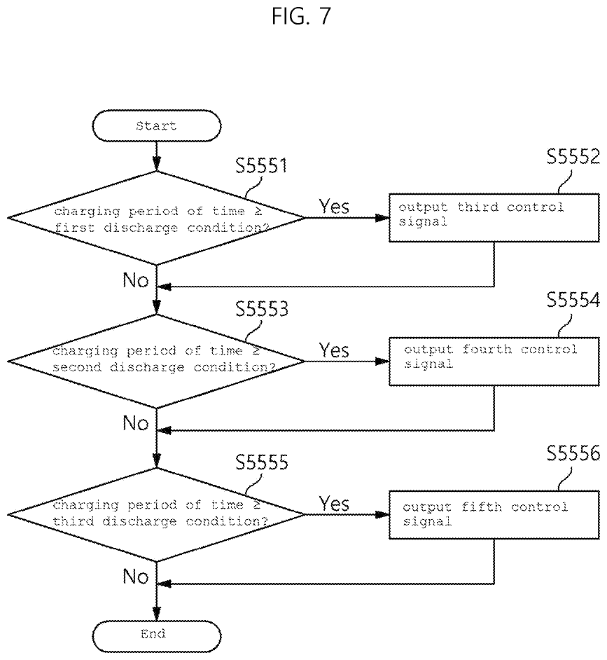

FIG. 7 is a flowchart for explaining operations according to control signals in a discharge mode among the battery protection methods according to embodiments of the present invention.

Referring to FIG. 7, when the battery protection apparatus is in discharge mode, the charging may be done by regenerative braking current. In other words, charging may be performed when the battery protection apparatus is in a discharge mode.

According embodiments, when in the discharge mode, the battery protection apparatus may identify whether the charging period of the charging current by the regenerative current satisfies a first discharge condition (S5551).

More specifically, when the battery protection apparatus operates in a discharge mode, if charging of the battery cell continues for more than a third time period at a first discharge temperature or less, the battery protection apparatus may output a third control signal and transmit it to the battery system (S5552). For example, the third control signal may be an output control signal. In addition, the first discharge temperature may be −15° C., and the third time period may be 1 second.

Accordingly, when the battery system receives the third control signal, the battery system may control the output of the battery cells by reducing the amount of output current required for the battery cells.

Thereafter, the battery protection apparatus may transmit a third release signal to the battery system when the temperature of the battery cells rises above the predetermined threshold temperature and the accumulated charging period is less than the predetermined threshold period. Accordingly, the battery system may stop output control of the battery cells, so that the battery cells may be discharged as its original state.

Meanwhile, when in the discharge mode, the battery protection apparatus may check whether the charging period of the charging current by the regenerative current satisfies a second discharge condition (S5553).

More specifically, when the battery protection apparatus operates in a discharge mode, if charging of the battery cell continues for more than a fourth time period at a second discharge temperature or lower, the battery protection apparatus may output a fourth control signal and transmit it to the battery system (S5554).

Accordingly, the battery system may block discharging of the battery cell when the fourth control signal is received. For example, the second discharge temperature may be −20° C., and the fourth period may be 1 second.

Thereafter, when the temperature of the battery cell exceeds the second discharge temperature, the accumulated charging time period is less than the predetermined threshold time period, and the battery cells are in an initialization state, the battery protection apparatus may transmit a fourth release signal to the battery system. Accordingly, the battery system may cancel the blocking of battery cell discharge. In other words, the battery cells may be re-discharged.

Additionally, in the discharge mode, the battery protection apparatus may check whether the charging period of the charging current by the regenerative braking current satisfies a third discharge condition (S5555).

More specifically, when the battery protection apparatus operates in a discharge mode, if charging of the battery cell continues for more than a fifth time period under a temperature condition equal to or below the third discharge temperature, the battery protection apparatus may output a fifth control signal and transmit it to the battery cells (S5556). For example, the third discharge temperature may be −20° C., and the fifth time period may be 3 seconds.

Accordingly, when the battery cell receives the fifth control signal, it may block a discharge switch to prevent charging current from flowing into the battery cell. Here, the discharge switch may be a discharge-FET (D-FET).

Thereafter, when the temperature of the battery cell exceeds the third discharge temperature, the accumulated charging period is less than a predetermined threshold period, and the battery cells are in an initialization state, the battery protection apparatus may transmit the fifth release signal to the battery system.

Accordingly, the battery cells may resume discharging by connecting the discharge switch.

The battery protection apparatus and method according to embodiments of the present invention have been described above.

The battery protection apparatus and method according to embodiments of the present invention may identify accumulated charging time period of charging current applied to the battery cell and determine whether to permanently block charging and discharging of the battery cell by comparing the accumulated charging time period with a predetermined threshold time period, thereby preventing battery cell ignition due to lithium plating occurring in the battery cell caused from charging current.

The operations of the method according to the embodiments and the experiment examples of the present invention may be implemented as a computer-readable program or code on a computer-readable recording medium. The computer-readable recording medium includes all types of recording devices in which data readable by a computer system is stored. In addition, the computer-readable recording medium may be distributed in a network-connected computer system to store and execute computer-readable programs or codes in a distributed manner.

In addition, the computer-readable recording medium may include hardware devices specially configured to store and execute program instructions, such as ROM, RAM, flash memory, etc. The program instructions may include not only machine language code created by a compiler, but also high-level language code that can be executed by a computer using an interpreter.

Although some aspects of the invention have been described in the context of the apparatus, it may also represent a description according to a corresponding method, wherein a block or apparatus corresponds to a method step or feature of a method step. Similarly, aspects described in the context of a method may also represent a feature of a corresponding block or item or a corresponding apparatus. Some or all of the method steps may be performed by (or using) a hardware device, such as, for example, a microprocessor, a programmable computer, or an electronic circuit. In some embodiments, one or more of the most important method steps may be performed by such an apparatus.

In the forgoing, the present invention has been described with reference to the exemplary embodiment of the present invention, but those skilled in the art may appreciate that the present invention may be variously corrected and changed within the range without departing from the spirit and the area of the present invention described in the appending claims.

1-24. (canceled)

25. An apparatus for protecting at least one battery cell located inside a battery system, the apparatus comprising:
at least one processor; and
a memory configured to store instructions which, when executed by the at least one processor, cause the at least one processor to perform:
an operation to identify an accumulated charging time period of a charging current applied to the at least one battery cell under a temperature condition less than or equal to a predetermined threshold temperature; and
an operation to determine whether to permanently block charging and discharging of the at least one battery cell by comparing the accumulated charging time period with a predetermined threshold time period.

26. The apparatus of claim 25, wherein the operation to determine whether to permanently block charging and discharging of the at least one battery cell includes an operation to permanently block charging and discharging of the at least one battery cell in an instance that the accumulated charging time period is greater than or equal to the predetermined threshold time period.

27. The apparatus of claim 25, wherein the operation to determine whether to permanently block charging and discharging of the at least one battery cell includes:
an operation to identify an operation mode of the at least one battery cell in an instance that the accumulated charging time period is less than the predetermined threshold time period; and
an operation to compare a charging time period of the at least one battery cell under the temperature condition less than or equal to the predetermined threshold temperature according to the operation mode with at least one predefined time period and to control charging and discharging of the at least one battery according to a comparison result.

28. The apparatus of claim 27, wherein the operation to control charging and discharging of the at least one battery cell includes an operation to:
upon the at least one battery cell being charged for more than or equal to a first time period under the temperature condition of less than or equal to the predetermined threshold temperature in a charge mode,
control the battery system to prevent charging of the at least one battery cell by transmitting a first control signal to the battery system.

29. The apparatus of claim 27, wherein the operation to control charging and discharging of the at least one battery cell includes an operation to:
upon the battery cell being charged for more than or equal to a second time period under the temperature condition of less than or equal to the predetermined threshold temperature in a charge mode,
transmit a second control signal to the at least one battery cell to block a charging switch of the at least one battery cell to prevent charging of the at least one battery cell.

30. The apparatus of claim 27, wherein the operation to control charging and discharging of the at least one battery cell includes an operation to:
upon the at least one battery cell being charged for more than or equal to a third time period under a temperature condition of less than or equal to a predefined first discharge temperature in a discharge mode,
transmit a third control signal to the battery system to control an amount of output current of the at least one battery cell.

31. The apparatus of claim 30, wherein the operation to control the amount of output current includes an operation to control reducing the amount of output current required for the at least one battery cell to a threshold value or less in the discharge mode.

32. The apparatus of claim 27, wherein the operation to control charging and discharging of the battery cell includes an operation to:
upon the at least one battery cell being charged for more than or equal to a fourth time period under a temperature condition of less than or equal to a predefined second discharge temperature in a discharge mode,
transmit a fourth control signal to the battery system to block a switch within the battery system to prevent discharging of the at least one battery cell.

33. The apparatus of claim 27, wherein the operation to control charging and discharging of the battery cell includes an operation to:
upon the at least one battery cell being charged for more than or equal to a fifth time period under a temperature condition of less than or equal to a predefined third discharge temperature in a discharge mode,
transmit a fifth control signal to the at least one battery cell to block a discharge switch of the at least one battery cell.

34. The apparatus of claim 27, wherein the operation to determine whether to permanently block charging and discharging of the at least one battery cell includes an operation to update the accumulated charging time period by reflecting the charging time in the accumulated charging time period.

35. A method for protecting at least one battery cell located inside a battery system, the method comprising:
identifying an accumulated charging time period of a charging current applied to the at least one battery cell under a temperature condition less than or equal to a predetermined threshold temperature; and
determining whether to permanently block charging and discharging of the at least one battery cell by comparing the accumulated charging time period with a predetermined threshold time period.

36. The method of claim 35, wherein the determining whether to permanently block charging and discharging of the at least one battery cell includes permanently blocking charging and discharging of the at least one battery cell in an instance that the accumulated charging time period is greater than or equal to the predetermined threshold time period.

37. The method of claim 35, wherein the determining whether to permanently block charging and discharging of the at least one battery cell includes:
identifying an operation mode of the at least one battery cell in an instance that the accumulated charging time period is less than the predetermined threshold time period; and
comparing a charging time period of the at least one battery cell under the temperature condition less than or equal to the predetermined threshold temperature according to the operation mode with at least one predefined time period and controlling charging and discharging of the at least one battery according to a comparison result.

38. The method of claim 37, wherein the controlling charging and discharging of the at least one battery according to the comparison result includes, upon the at least one battery cell being charged for more than or equal to a first time period under the temperature condition of less than or equal to the predetermined threshold temperature in a charge mode, controlling the battery system to prevent charging of the at least one battery cell by transmitting a first control signal to the battery system.

39. The method of claim 37, wherein the controlling charging and discharging of the at least one battery according to the comparison result includes, upon the at least one battery cell being charged for more than or equal to a second time period under the temperature condition of less than or equal to the predetermined threshold temperature in a charge mode, transmitting a second control signal to the at least one battery cell to block a charging switch of the at least one battery cell to prevent charging of the at least one battery cell.

40. The method of claim 37, wherein the controlling charging and discharging of the at least one battery according to the comparison result includes, upon the at least one battery cell being charged for more than or equal to a third time period under a temperature condition of less than or equal to a predefined first discharge temperature in a discharge mode, transmitting a third control signal to the battery system and controlling an amount of output current of the at least one battery cell.

41. The method of claim 40, wherein the controlling the amount of output current of the at least one battery cell includes controlling to reduce the amount of output current required for the at least one battery cell to a threshold value or less in the discharge mode.

42. The method of claim 37, wherein the controlling charging and discharging of the at least one battery according to the comparison result includes, upon the at least one battery cell being charged for more than or equal to a fourth time period under a temperature condition of less than or equal to a predefined second discharge temperature in a discharge mode, transmitting a fourth control signal to the battery system to block a switch within the battery system to prevent discharging of the at least one battery cell.

43. The method of claim 37, wherein the controlling charging and discharging of the at least one battery according to the comparison result includes, upon the at least one battery cell being charged for more than or equal to a fifth time period under a temperature condition of less than or equal to a predefined third discharge temperature in a discharge mode, transmitting a fifth control signal to the at least one battery cell to block a discharge switch of the at least one battery cell.

44. The method of claim 37, wherein the determining whether to permanently block charging and discharging of the at least one battery cell includes updating the accumulated charging time period by reflecting the charging time in the accumulated charging time period.
